(19) United States
(12) Patent Application Publication
(10) Pub. No.: US 2015/0356852 A1
(43) Pub. Date: Dec. 10, 2015

(54) Temperature and Humidity Alerting System

(71) Applicants: Jorge Estrada, Glendale, CA (US); Henry Chen, Los Angeles, CA (US); Zacharias Purnajo, Temple City, CA (US)

(72) Inventors: Jorge Estrada, Glendale, CA (US); Henry Chen, Los Angeles, CA (US); Zacharias Purnajo, Temple City, CA (US)

(21) Appl. No.: 14/299,305

(22) Filed: Jun. 9, 2014

(51) Int. Cl. G08B 21/18

(52) U.S. Cl. CPC G08B 21/182

(57) ABSTRACT

A temperature and humidity alerting system (THAS) that is designed to alert a medical practitioner or a caregiver when a clothed, diapered or bedridden person has inadvertently urinated or defecated. The THAS is comprised of a data transmitting unit and a data receiving unit. The data transmitting unit utilizes a temperature indicating probe and a humidity indicating probe that each produce a signal when their threshold temperature and/or humidity levels are exceeded. The resulting signal is applied to a data receiving unit where the signal is further processed by a microprocessor that produces a data output signal and a humidity output signal that are applied to an alpha-numeric unit where the data is displayed.

### TECHNICAL FIELD

The invention generally pertains to temperature and humidity sensors and more particularly to a temperature and humidity alerting system (THAS) that allows a remotely located caregiver to be alerted when a person has inadvertently urinated or defecated while clothed or when bedridden.

### BACKGROUND ART

Currently in the prior art there are methods and electronic equipment that function in combination with a plurality of sensors to provide data pertaining to a person's health and/or physical condition. The sensors are attached to selected areas of a person's body to monitor the person's vital signs such as heart rate and temperature. When the heart rate or temperature exceeds a preset level, an alarm alerts a nurse or a caretaker that a potential medical problem exists.

The prior art equipment does not include a method or equipment that specifically is designed to monitor a bedridden or clothed patient who has inadvertently urinated or defecated. In particular, when a diapered infant has an accident, prior art disclosing a means for determining that a diaper has been soiled was not located.

A search of the prior art did not disclose any literature or patents that read directly on the claims of the instant invention. However, the following U.S. patents are considered related:

| PATENT NO. | INVENTOR | ISSUED |
|---|---|---|
| 8,413,505 | Chien | 9 Apr. 2013 |
| 6,483,324 | Mitter | 19 Nov. 2002 |
| 4,737,707 | Mori | 12 Apr. 1988 |

The 8,413,505 patent discloses a temperature and humidity measuring and recording device. The device is used for measuring and recording the temperature and humidity of an interior station.
The 6,483,324 patent discloses a device for measuring moisture. The device includes a sensor unit having a moisture-sensitive sensor and a carrier element, upon which the sensor is mounted. The carrier element and the sensor have electrical contact regions. The carrier element has an upper recess upon which the sensor unit is mounted. The moisture-sensitive sensor is oriented in the direction of the recess.
The 4,737,707 patent discloses a humidity sensing portion and an electrode of a heating regeneration type humidity sensor that is provided with a heater covered by a casing and a holding portion. An opening for communication is placed between the interior and the exterior of the sensor.

For background purposes and indicative of the art to which the invention relates, reference may be made to the following remaining patents found in the patent search.

| PATENT NO. | INVENTOR | ISSUED |
|---|---|---|
| D460,923 | Chen | 30 Jul. 2002 |
| D300,727 | Fukushima | 18 Apr. 1989 |

### DISCLOSURE OF THE INVENTION

The temperature and humidity alerting system (THAS) provides a non-invasive and an expedient method for monitoring a clothed, bedridden person or an infant who have inadvertently urinated or defecated. In its basic design configuration the THAS is comprised of:

A. A data transmitting unit having means for producing a temperature signal derived from a temperature indicating probe and a humidity signal derived from a humidity indicating probe. Each probe is disposable and is located between a person's skin and an interfacing article of clothing such as a diaper. The temperature and humidity signals are applied to and are processed by a microprocessor that produces a processed temperature signal and a processed humidity signal. Each signal is applied to a wireless transmitting circuit which produces a temperature output signal and humidity output signal that are each applied via an antenna into outer space.

B. A wireless data receiving unit that receives the temperature and humidity output signals that are then applied to and are further processed by a microprocessor. The microprocessor produces a temperature data signal and a humidity data signal that are applied to a data alert circuit where a person's temperature and humidity data are displayed.

The data transmitting unit, which is also referred to as a base unit, utilizes the temperature indicating probe in combination with the humidity indicating probe. The two probes are inserted between a person's skin and an article of clothing such as a diaper. When a clothed or bedridden person has an accident which is defined as inadvertently urinating or defecating, the two probes sense a change of body temperature and humidity. This change causes the probes to produce respectively a temperature signal and a humidity signal that are both applied to the microprocessor.

If the program or algorithm stored in the microprocessor determines that an accident has occurred, three actions are provide by the microprocessor:

1. an audio alarm is activated,

2. an accident alarm LED illuminates, and

3. the temperature and humidity data is remotely sent from the data transmitting unit to the data receiving unit.

The wireless data receiving unit is remotely located such as in a caregiver or nurses station where an accident incident can be readily observed and/or heard, thus allowing corrective action to be taken. The temperature and the humidity output signals received by the data receiving unit are applied to a microprocessor when produces a temperature data and humidity data signal which are applied to an alpha-numeric display where a person's temperature and humidity data is displayed.

In view of the above disclosure, the primary object of the invention is to produce a temperature and humidity alerting system (THAS) that reliably provides a visual and audio alarm when a clothed or bedridden person inadvertently urinates or defecates.

In addition to the primary object of the invention it is also an object of the invention to provide an invention that:
is simple to operate,
is easily maintained,
has a long useful life,
can be used in a home or a medical facility,
can be utilized for both infants and adults, and
is cost effective from both a manufacturer's and consumer's point of view.

These and other objects and advantages of the present invention will become apparent from the sub sequent detailed description of the preferred embodiment and the appended claims taken in conjunction with the accompanying drawings.

### BRIEF DESCRIPTION OF THE DRAWINGS

FIG. 1 is a block diagram of the overall temperature and humidity alerting system (THAS).

FIG. 2 is a block diagram of the data transmitting unit.

FIG. 3 is a block diagram of the data receiving unit.

FIG. 4 is a block/flow diagram of a typical firmware program used to operate the data transmitting unit.

FIG. 5 is a block flow diagram of a typical firmware program used to operate the data receiving unit.

### BEST MODE FOR CARRYING OUT THE INVENTION

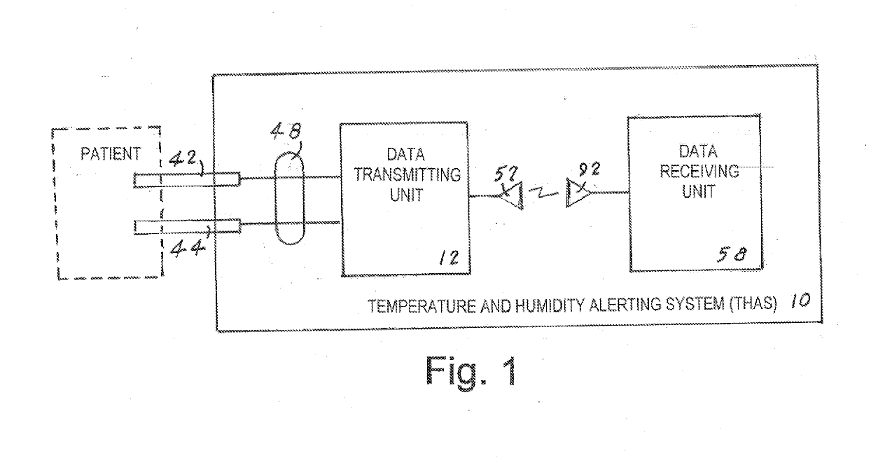

The best mode for carrying out the invention is presented in terms that disclose a preferred embodiment of a temperature and humidity alerting system (THAS) 10. The THAS 10 is designed to alert a medical practitioner or caregiver that a person who is bedridden or clothed, such as with a diaper, has inadvertently urinated or defecated while still clothed. The THAS 10, as shown in FIGS. 1-5, is comprised of two major elements: a data transmitting unit 12 typically located at a base station, and a remotely located data receiving unit 58 typically located at a nurses station. The overall THAS 10 is shown in FIG. 1.

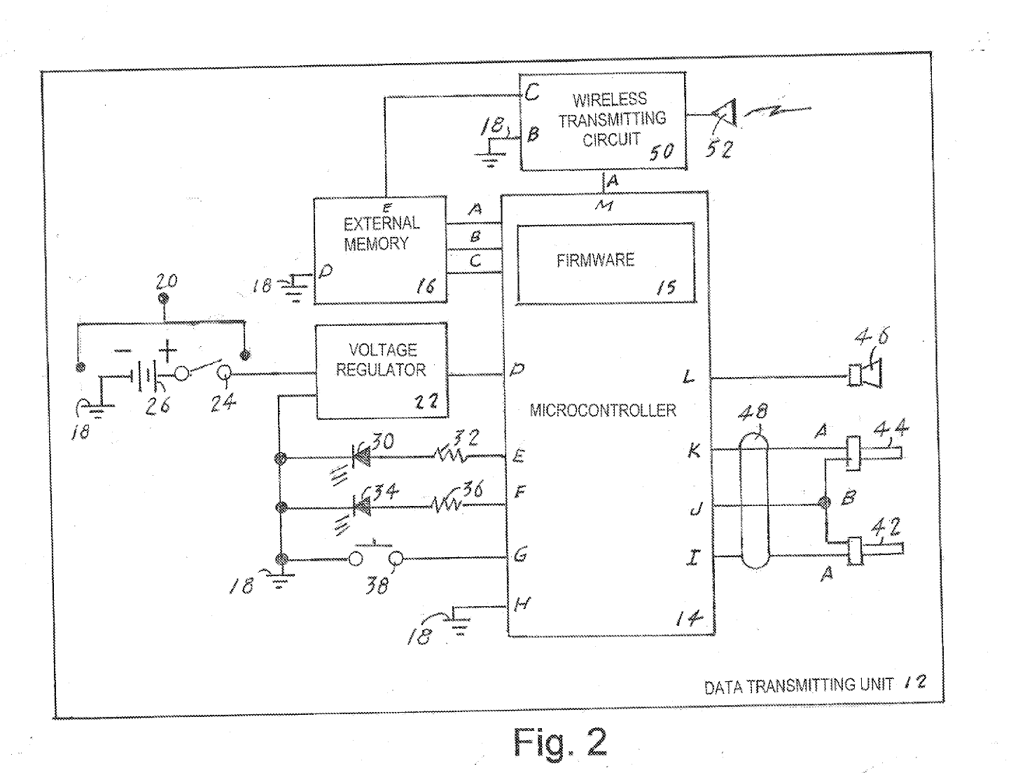

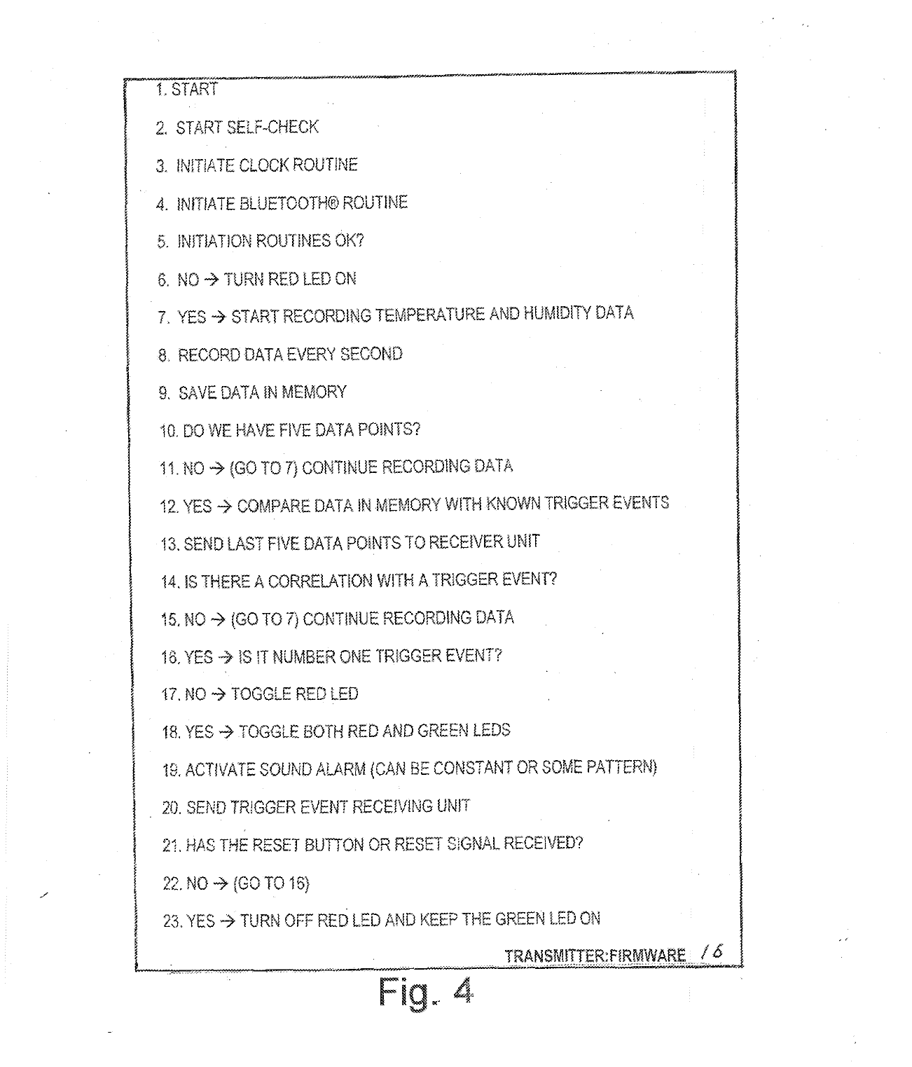

The data transmitting unit 12, as best shown in FIG. 2, is comprised of a microcontroller or a microprocessor 14, wherein each function in combination with firmware 15, as shown in FIG. 4. Microcontrollers have the ability to be re-programmed at anytime during its useful life cycle. Thus, if the THAS 10 is in production and the firmware 15 requires a change, the microcontroller 14 is simply re-programmed with the new firmware 15. For brevity, only the microprocessor 14 is referred to in the remaining disclosure.

The microprocessor 14, as shown in FIG. 2, has a plurality of connections ranging from pins A-M. Pins A-C are connected to pins A-C located on an external memory 16, which also has a pin connected to circuit ground 18 and a pin E. Microprocessors typically have a limited amount of volatile memory for temporary storage of data which can be lost if power is removed. To preclude the loss of data the THAS 10 utilizes the external memory 16 which is in the form of an Electrically Erasable Programmable Read-Only Memory (EEPROM) that can store data and retain the data if electrical power to the THAS 10 is lost. The EEPROM also allows data to be erased and overwritten, such as when a new patient is connected to the THAS 10. As shown in FIG. 2, the microprocessor 14 includes a system reset switch 38 that is connected to pin G on the microprocessor 14 and to circuit ground 18.

The input applied to the THAS 10 is comprised of two probes: a temperature indicating probe 42 and a humidity indicating probe 44, both of which are preferably disposable. The probes can consist of individual probes, as shown in FIG. 2, or multiple probes can be contained within a single enclosure (not shown). The probes have a substantially flat cross-section which allows them to be easily inserted and be comfortably retained when placed between a person's skin and an article of clothing such as underwear or a diaper. The temperature indicating probe 42, 44, as best shown in FIG. 2, has a first pin A connected to pin I on the microprocessor 14 and a probe return pin B connected to pin J on the microprocessor 14. Likewise, the humidity indicating probe 44 also has a pin A connected to pin K on the microprocessor 14 and a pin 13 connected to pin J on the microprocessor 14. The probes 42, 44, as shown in FIG. 2, are preferably connected to the microcontroller 14 by means of a cable 48.

The electrical power to the THAS 10 is provided by a power input circuit 20, as shown in FIG. 2, that is comprised of a voltage regulator 22 having a pin A connected to a pin D on the microprocessor 14, a pin B connected sequentially to a power switch 24 and to the positive (+) terminal on a battery 26, which is preferably comprised of a rechargeable battery. The negative (−) terminal of the battery is connected to circuit ground 18. When the power switch 24 is closed, power from the voltage regulator 22 is applied to the microprocessor 14, which causes a power-on LED 30 to illuminate. The LED 30 is connected through a current limiting resistor 32 to pin E on the microprocessor 14.

When either one or both of the probes 42, 44 are activated, the microprocessor 14 produces a signal that illuminates an incident alarm LED 34 which is connected through a current limiting resistor 36 that is connected to pin F on the microprocessor 14. Concurrently with the illumination of the LED 34, a loudspeaker 46 produces an audio alarm. The loudspeaker 46, as shown in FIG. 2, is connected to pin L on the microprocessor 14.

The output provided by the data transmitting unit 12 is a temperature data signal that is produced by a wireless transmitting circuit 50 which has a pin A connected to a pin M on the microprocessor 14, a pin B connected to circuit ground 18, a pin C connected to pin E on the external memory 16, and a pin D connected to a transmitting antenna 52. The wireless transmitting unit 50 can be comprised of an RF transmitter, BLUETOOTH® or other wireless technology transmitting circuit.

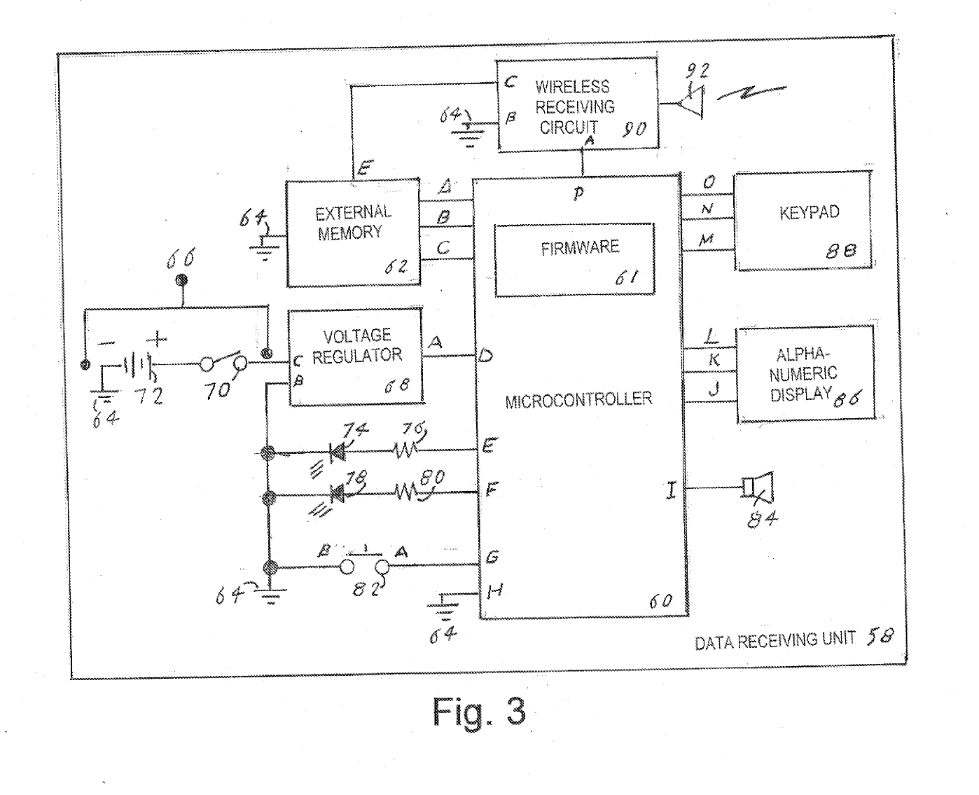

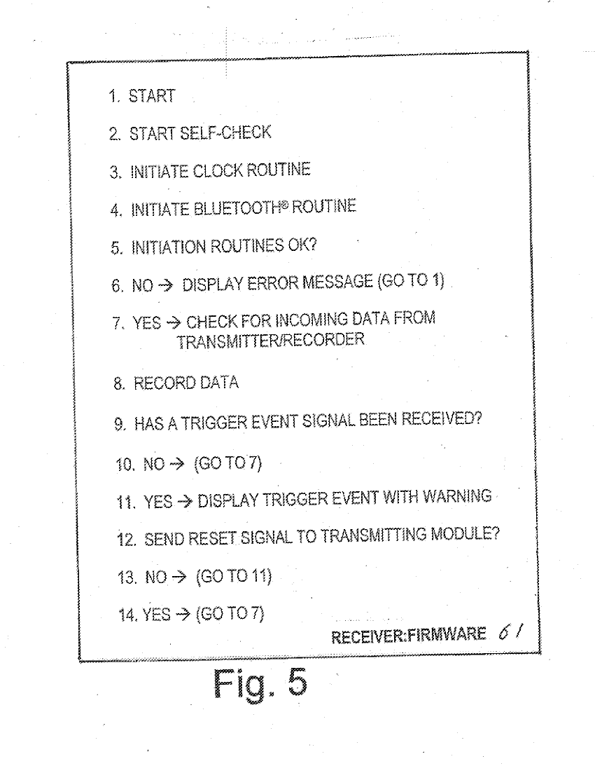

The second major element of the THAS 10, as shown in FIG. 3, is the data receiving unit 58 which is comprised of a microprocessor 60 that functions in combination with firmware 61, as shown in FIG. 5. The receiving unit 58 can be comprised of a hand-held device such as a cell phone or a tablet.

The microprocessor 60, as shown in FIG. 3, has a plurality of connections ranging from pins A-P. Pins A-C on the microprocessor 60 are connected to pins A-C on an external memory 62 that is comprised of an EEPROM as disclosed in the section covering the data transmitting unit 12. The external memory also has a pin D connected to circuit ground 64 and a pin E connected to a receiving circuit 90 described infra. The microprocessor 60 includes a system reset switch 82 having a pin A that is connected to pin G on the microprocessor 60 and a pin B connected to circuit ground 64.

The electrical power to the THAS 10 is provided by a power input circuit 66, as shown in FIG. 3, that is comprised of a voltage regulator 68 having a pin A connected to a pin D on the Microprocessor 60, a pin 13 connected to circuit ground 64, and a pin C that is connected sequentially to a power switch 70 and to the positive (+) terminal on a battery 72. The (−) terminal is connected to circuit ground 64. When power is applied from the regulator 68 and the power switch 70 is closed, a power-on LED 74 illuminates. The LED 74 has its anode connected through a current limiting resistor 76 to pin E on the microprocessor 60. Concurrently with the illumination of the LED 74 an accident alarm LED 78 also illuminates. The LED 78 has its anode connected through a current limiting resistor 80 to pin F on the microprocessor 60. The microprocessor 60 also has a pin I that is attached to a loudspeaker 84 which provides an audio alarm concurrently with the illumination of the LED 78.

The output from the wireless transmitting circuit 50 is received by wireless receiving circuit 90, as shown in FIGS. 1 and 3. The wireless receiver circuit 90, which can be designed to either receive a RF signal, a BLUETOOTH® signal, or other wireless signals, has a pin A connected to pin P on the microprocessor 60, a pin B connected to circuit ground 64, a pin C connected to a pin E on the memory circuit 62, and a pin D connected to a receiving antenna 92.

The data receiving unit 58 also includes an alpha-numeric display 86 and a keypad 88. The display 86, as shown in FIG. 3, has a power pin J, a data pin K and a ground pin L connected respectively to pins J, K and L on the microprocessor 60. The keypad 88 has a power pin M, a data pin N and a ground pin O connected respectively to pins M, N and O on the microprocessor 60.

The alpha-numeric display 86 allows the data received by the data receiving unit 58 to be easily viewed. As shown in FIG. 3, the alpha-numeric display 86 has a power pin J, a data pin K and a ground pin L connected respectively to pins J, K and L on the microprocessor 60.

The keypad 88 allows numbers and letters to be entered. The keypad can include a “patient data key”. Pressing this key causes the microprocessor program to step through a list of pre-selected questions that can include data such as the patient's name and address, date of birth, age, etc. The keypad 88 also allows the medical practitioner to set a computer clock to the present time and data. Having a clock in the THAS 10 also allows the system to log the time and date of each accident occurrence. This provides the medical practitioner or caregiver with accurate data as to when and how often the patient is having an accident occurrence.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A temperature and humidity alerting system (THAS) comprising:
a) a data transmitting unit having means for producing a temperature signal derived from a temperature indicating probe and a humidity signal derived from a humidity indicating probe, wherein each said probe is located between a person's skin and an interfacing article of clothing which includes a diaper, wherein the temperature and humidity signals are applied to and are processed by a microprocessor that functions in combination with a transmitter firmware to produce a processed temperature signal and a processed humidity signal which are each applied to a wireless transmitting circuit having means for producing a temperature output signal and a humidity output signal that are applied into outer space, and
b) a wireless data receiving unit having means for receiving the temperature and humidity output signals that are then applied to and are further processed by a microprocessor which produces a temperature data signal and a humidity data signal that are each applied to a data alert circuit.

2. The THAS as specified in claim 1 wherein said temperature and humidity indicting probes are disposable and are contained within a single enclosure having a substantially flat cross-section which allows said probes to be easily inserted into and comfortably retained by a person.

3. The THAS as specified in claim 1 further comprising an external memory connected to said microprocessor.

4. The THAS as specified in claim 3 wherein said external memory is comprised of an EEPROM integrated circuit.

5. The THAS as specified in claim 1 further comprising a power input circuit comprising a voltage regulator having an output connected to said microprocessor and an input connected sequentially through an on-off power switch and a battery, wherein when power is available an LED connected to said microprocessor illuminates.

6. The THAS as specified in claim 1 wherein said battery is further comprised of a rechargeable battery.

7. The THAS as specified in claim 1 wherein said data alert circuit is activated by a said microprocessor when a change in a person's base temperature and humidity has occurred.

8. The THAS as specified in claim 7 wherein said data alert circuit is comprised of an alpha-numeric display connected to said microprocessor on said wireless data receiving unit.

9. The THAS as specified in claim 7 wherein said data alert circuit is comprised of an accident alert LED connected to each respective said microprocessor.

10. The THAS as specified in claim 7 wherein said data alert circuit is comprised of a loudspeaker that is connected to each respective said microprocessor.

11. The THAS as specified in claim 1 further comprising a microprocessor reset switch connected to each respective said microprocessor.

12. The THAS as specified in claim 1 wherein said transmitting circuit is comprised of an RF transmitter that provides through an antenna, an RF temperature and humidity temperature output signal.

13. The THAS as specified in claim 1 wherein said transmitting circuit is comprised of a circuit employing BLUETOOTH® wireless technology.

14. The THAS as specified in claim 1 wherein said data receiving unit further comprises a keypad that is connected to said microprocessor.

15. A temperature and humidity alerting system (THAS) comprising:
A) a data transmitting unit (12) comprising:
a) a microprocessor (14) that functions in combination with firmware (15) and that has a plurality of pins (A-M),
b) an external memory (16) having a plurality of pins (A-E), wherein pins (A-C) are connected to pins (A-C) on said microprocessor (14) and pin D is connected to circuit ground (18),
c) a power input circuit (20) comprising a voltage regulator (22) having a pin (A) connected to pin (D) on said microprocessor (14), a pin (B) connected to circuit ground (18), and a pin (C) connected sequentially to a power switch (24) and to the positive (+) terminal on a battery (26),
d) a power-on LED (30) connected through a current limiting resistor (32) to pin (E) on said microprocessor (14),
e) an accident alarm LED (34) connected through a current limiting resistor (36) to pin (F) on said microprocessor (14),
f) a system reset switch (38) having a first contact (A) connected to pin (G) on said microprocessor (14) and a second contact (D) connected to circuit ground (18),
g) a temperature indicating probe (42) having a first pin (A) connected to pin (I) on said microprocessor (14) and a probe return pin (B) connected to pin (J) on said microprocessor (14),
h) a humidity indicating probe (44) having a first pin (A) connected to pin (K) on said microprocessor (14) and a pin (B) connected to pin (J) on said microprocessor (14) which said probes (42, (44) are attached to said microcontroller (14) via a cable (48),
i) a moisture/temperature alerting loudspeaker (46) connected to pin (L) on said microprocessor (14), and
j) a wireless transmitting circuit (50) having a pin (A) connected to pin (M) on said microprocessor (14), a pin (B) connected to circuit ground (18), a pin (C) connected to pin (E) on said external memory (16), and a pin (D) connected to a transmitting antenna (52),
B) a data receiving unit (58) comprising:
a) a microprocessor (60) having a plurality of pins (A-P), that functions in combination with a receiver firmware (61),
b) an external memory (62) having a plurality of pins (A-E), wherein pins (A-C) are respectively connected to pins (A-C) on said microprocessor (60), pin (D) is connected to circuit ground (64), and pin (E) is connected to pin (C) on said receiving circuit,
c) a power input circuit (66) comprising a voltage regulator (68) having a pin (A) connected to pin (D) on said microprocessor (60), a pin (B) connected to circuit ground (64), and a pin (C) connected sequentially to a power switch (70) and to the positive (+) terminal on a battery (72), and the (−) terminal connected to circuit ground (64),
d) a power ON LED (74) having its anode connected through a current limiting resistor (76) to pin (E) on said microprocessor (60),
e) an accident alarm LED (78) having its anode connected through a current limiting resistor (80) to pin (F) on said microprocessor (60),
f) a system reset switch (82) having a first contact (A) connected to pin (G) on said microprocessor (60) and a second contact (B) connected to circuit ground (64),
g) a moisture/temperature alerting loudspeaker (84) connected to pin (I) on said microprocessor (60),
h) an alpha-numeric display (86) having a power pin (J), a data pin (K) and a ground pin (L) connected respectively to pins (J, K and L) on said microprocessor (60),
i) a keypad (88) having a power pin (M), a data pin (N) and a ground pin (O) connected respectively to pins (M, N and O) on said microprocessor (60), and
j) a wireless receiving circuit (90) having a pin (A) connected to pin (P) on said microprocessor (60), a pin (B) connected to circuit ground (64), pin (C) connected to a pin (E) on said memory circuit (62), and a pin (D) connected to receiving antenna (84).

16. The THAS as specified in claim 15 wherein said wireless transmitting circuit is comprised of an RF transmitter.

17. The THAS as specified in claim 15 wherein said wireless transmitting circuit is comprised of a circuit employing BLUETOOTH® wireless technology.

18. The THAS as specified in claim 15 wherein each said probe has a substantially flat cross-section.

19. The THAS as specified in claim 15 wherein said microprocessor is further comprised of a microcontroller.
